(19) United States
(12) Patent Application Publication
(10) Pub. No.: US 2025/0142496 A1
(43) Pub. Date: May 1, 2025

(54) TECHNIQUES FOR COMMUNICATING SIDELINK SYNCHRONIZATION SIGNALS IN EXISTING WIRELESS COMMUNICATION DEPLOYMENTS

(71) Applicant: QUALCOMM INCORPORATED, San Diego, CA (US)

(72) Inventors: Tien Viet NGUYEN, Bridgewater, NJ (US); Kapil GULATI, Belle Mead, NJ (US); Shijun WU, San Diego, CA (US); Hui GUO, Beijing (CN); Shailesh PATIL, San Diego, CA (US); Gene Wesley MARSH, San Diego, CA (US)

(21) Appl. No.: 18/837,845

(22) PCT Filed: Apr. 19, 2022
(86) PCT No.: PCT/CN2022/087580

§ 371 Date: Aug. 12, 2024

(51) Int. Cl. H04W 56/00; H04L 5/00

(52) U.S. Cl. CPC H04W 56/001; H04L 5/005

(57) ABSTRACT

Some aspects described herein relate configuring resources in one or more slots for communicating a sidelink synchronization signal (SLSS) while maintaining a logical numbering of multiple consecutive slots including the one or more slots. Based on configuring the at least one slot a SLSS can be received from a node or transmitted to one or more nodes during at least one slot of the one or more slots.

### BACKGROUND

Aspects of the present disclosure relate generally to sidelink wireless communication systems, and more particularly, to synchronizing sidelink communications.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable low-latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in 5G communications technology and beyond may be desired.

In some wireless communication technologies, such as 5G, user equipment (UEs) communicate over one or more of multiple interfaces. The multiple interfaces may include a Uu interface between the UE and a base station, where the UE can receive communications from the base station over a downlink and transmit communications to the base station over an uplink. In addition, the multiple interfaces may include a sidelink interface to communicate with one or more other UEs directly over a sidelink channel (e.g., without traversing the base station).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, a memory configured to store instructions, and one or more processors communicatively coupled with the memory and the transceiver. The one or more processors are configured to configure resources in one or more slots for communicating a sidelink synchronization signal (SLSS) while maintaining a logical numbering of multiple consecutive slots including the one or more slots, and at least one of: receive, during at least one slot of the one or more slots, a SLSS from a node; or transmit, during at least one slot of the one or more slots, a SLSS to one or more nodes.

In another aspect, a method for wireless communication is provided that includes configuring resources in one or more slots for communicating a SLSS while maintaining a logical numbering of multiple consecutive slots including the one or more slots, and at least one of: receiving, during at least one slot of the one or more slots, a SLSS from a node; or transmitting, during at least one slot of the one or more slots, a SLSS to one or more nodes.

In another aspect, an apparatus for wireless communication is provided that includes means for configuring resources in one or more slots for communicating a SLSS while maintaining a logical numbering of multiple consecutive slots including the one or more slots, and at least one of: means for receiving, during at least one slot of the one or more slots, a SLSS from a node; or means for transmitting, during at least one slot of the one or more slots, a SLSS to one or more nodes.

In another aspect, a computer-readable medium is provided that includes code executable by one or more processors for wireless communications. The code includes code for configuring resources in one or more slots for communicating a SLSS while maintaining a logical numbering of multiple consecutive slots including the one or more slots, and at least one of: code for receiving, during at least one slot of the one or more slots, a SLSS from a node; or code for transmitting, during at least one slot of the one or more slots, a SLSS to one or more nodes.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a block diagram illustrating an example of a user equipment (UE), in accordance with various aspects of the present disclosure;

FIG. 3 is a flow chart illustrating an example of a method for configuring resources for communicating sidelink synchronization signals (SLSS), in accordance with various aspects of the present disclosure;

FIG. 4 illustrates an example of a resource allocation for transmitting scheduling assignments (SA) to reserve resources for SLSS communication, in accordance with various aspects of the present disclosure; and

FIG. 5 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to synchronizing devices using sidelink (SL) communications. For example, SL communications can refer to device-to-device (D2D) communication among devices (e.g., user equipment (UEs)) in a wireless network. In a specific example, SL communications can be defined for vehicle-based communications, such as vehicle-to-vehicle (V2V) communications between two vehicle-based communication device that are on a vehicle (e.g., onboard units (OBUs), vehicle-to-infrastructure (V2I) communications (e.g., from a vehicle-based communication device, such as a OBU, to a road infrastructure node (e.g., roadside unit (RSU)), vehicle-to-network (V2N) communications (e.g., from a vehicle-based communication device to one or more network nodes, such as a base station), a combination thereof and/or with other devices, which can be collectively referred to as vehicle-to-anything (V2X) communications. In V2X communications, OBUs can communicate with one another and/or with RSUs over a SL channel.

V2X communications can occur over one or more slots. A slot can be defined in a wireless communication technology (e.g., third generation partnership project (3GPP) long term evolution (LTE) or fifth generation (5G) new radio (NR), etc.) as including a collection of multiple symbols, where the multiple symbols can be one of orthogonal frequency division multiplexing (OFDM) symbols, single carrier-frequency division multiplexing (SC-FDM) symbols, or other types of symbols. In an example, the number of symbols in a slot may vary based on a cyclic prefix (CP) length defined for the symbols.

In LTE V2X, for example, a UE can synchronize timing and/or frequency to one or more of a satellite source, such as a global navigation satellite system (GNSS), or to another UE using a sidelink synchronization signal (SLSS). In some LTE V2X deployments, evolved Node Bs (eNBs) may not be present, such as deployments in intelligent transport system (ITS) spectrum, and GNSS may be a main synchronization source for the UEs. In some regions or scenarios (e.g., in a tunnel, parking garage, or other scenarios where the UE may not have clear line-of-sight to GNSS), however, a UE may not be able to receive GNSS signals for synchronization, and UEs can transmit SLSS to one another to propagate GNSS timing. In some examples, a RSU, which can be static in position or location as compared to a OBU, can provide SLSS to vehicle-based communication devices (OBUs), where the RSU can directly synchronize to GNSS or indirectly synchronize to GNSS via other RSU SLSS.

In some configurations of LTE V2X, however, SLSS features may not be provisioned, as there may not be a slot reserved for sending and receiving SLSS signals. LTE standards may allow for enabling SLSS, which can create slots reserved for SLSS and can change the way UEs calculate logical slot index. For example, UEs enabled for SLSS may skip an SLSS slot in determining incremental slot indices for non-SLSS slots. Logical slot index calculation allows the UEs to determine where to expect data reception and/or where to expect interference from other UE transmissions. In a deployment of LTE V2X where UEs are produced before SLSS features are introduced may follow a different logical slot index than UEs produced after SLSS features are introduced. As such, for example, the two types of UEs may not communicate well with one another and may interfere more often as semi-persistent scheduling (SPS) reservations may equate to different slots as interpreted by the two types of UEs.

For example, in LTE V2X, a UE can receive a scheduling assignment (SA) from other UEs indicating a number of reserved subchannels, a resource reservation period (P_rsvp), a retransmission time gap (TRIV), and a retransmission start subchannel (FRIV) that are reserved by the other UEs. In this example, the UE receiving the SA can know which resources are to be used by other UEs in the future. TRIV and P_rsvp can be converted number of logical slot for this purpose. Accordingly, the UE can form a set of candidate resources that are not reserved, and can rank the set of candidate resources based on measured signal strength (e.g., received signal strength indicator (RSSI)). The UE can select the resources among the lowest ranked RSSI to transmit as interference is expected to be smallest over the selected resources. When the UEs have different mechanisms for computing the logical slot index, however, the UEs may differently interpret the P_rsvp, TRIB, or FRIV, and thus a UE may select resources for transmitting that conflict with transmissions from other UEs.

Aspects described herein relate to using SLSS in LTE where UEs that support SLSS and UEs that do not support SLSS can compute a same logical slot index for a given slot. In an example, some slots can be reserved for SLSS transmission (e.g., from a RSU), and OBUs that do not support SLSS need not transmit on those slots, so as not to interfere with the SLSS transmissions. This can improve receipt of the SLSS by devices that support SLSS and can ensure data transmission from devices that do not support SLSS is received without interference from SLSS as well. In an example, SLSS resources can be configured without actually configuring SLSS via radio resource configuration (RRC) parameters. This can prevent UEs from computing different logical slot indices, as described above. In addition, for example, the SLSS resources can be configured every few milliseconds for SLSS communication (e.g., transmission and/or reception). In this example, UEs that support SLSS can transmit SLSS in the slot, which can create RSSI energy at the resource such that devices that do not support SLSS may be deterred from using the resource for data communications. In another example, UEs that support SLSS can send a SA without data to reserve SLSS resources, and the devices that do not support SLSS may refrain from using these resources for data communications based on the SA. In another example, UEs that support SLSS can send a SA without data in the first 2 resource blocks (RBs) of the slots to reserve SLSS slots, and the devices that do not support SLSS may refrain from using these slots for data communications based on the SA.

The aspects described herein can allow for implementing SLSS communication in LTE V2X deployments having UEs that do not support SLSS without causing different number of logical slot indices among UEs. This can facilitate improved resource determination and interference mitigation among UEs while allowing for SLSS functionality. Using SLSSs, in this regard, can facilitate improved synchronization among UEs that support SLSS, which can improve quality of communications and communication throughput for the devices, which can improve user experience, etc.

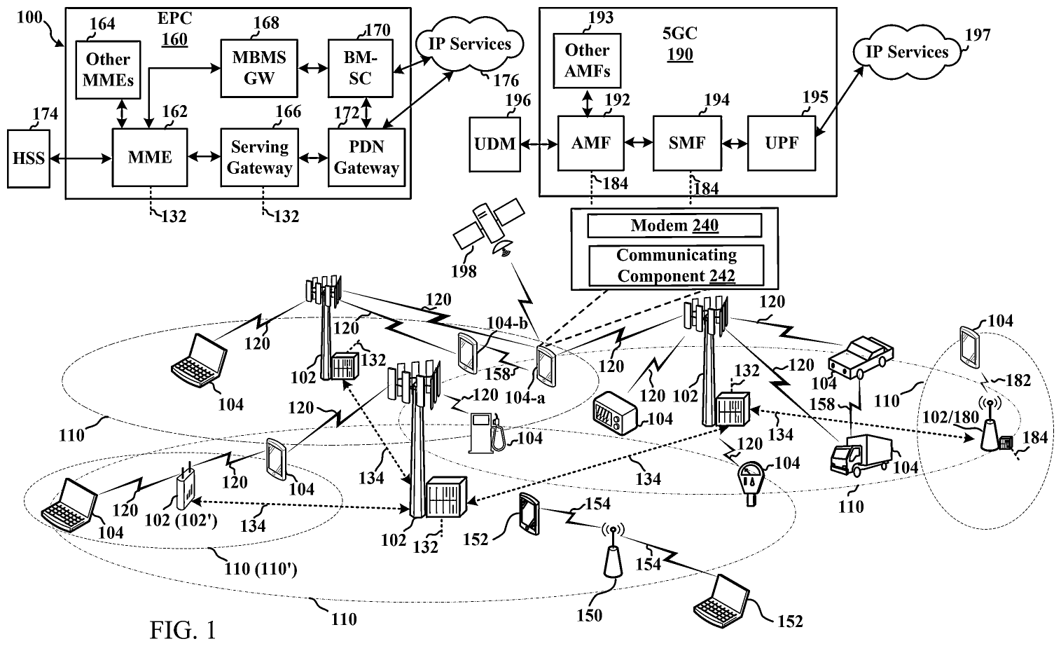

The described features will be presented in more detail below with reference to FIGS. 1-5.

As used in this application, the terms “component,” “module,” “system” and the like are intended to include a computer-related entity, such as but not limited to hardware, software, a combination of hardware and software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 240 and communicating component 242 for communicating SLSSs, as described further herein. Though UE 104-a is shown as having the modem 240 and communicating component 242, this is one illustrative example, and substantially any node or type of node may include a modem 240 and communicating component 242 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an SI interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs (e.g., UE 104-a and 104-b) may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network. In addition, in this regard, UEs 104-a, 104-b can use a portion of frequency in the 5 GHz unlicensed frequency spectrum in communicating with the small cell 102′, with other cells, with one another using sidelink communications, etc. The UEs 104-a, 104-b, small cell 102′, other cells, etc. can use other unlicensed frequency spectrums as well, such as a portion of frequency in the 60 GHz unlicensed frequency spectrum.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a positioning system (e.g., satellite, terrestrial), a multimedia device, a video device, a digital audio player (e.g., MP3 player), a camera, a game console, a tablet, a smart device, robots, drones, an industrial/manufacturing device, a wearable device (e.g., a smart watch, smart clothing, smart glasses, virtual reality goggles, a smart wristband, smart jewelry (e.g., a smart ring, a smart bracelet)), a vehicle/a vehicular device, a meter (e.g., parking meter, electric meter, gas meter, water meter, flow meter), a gas pump, a large or small kitchen appliance, a medical/healthcare device, an implant, a sensor/actuator, a display, or any other similar functioning device. Some of the UEs 104 may be referred to as IoT devices (e.g., meters, pumps, monitors, cameras, industrial/manufacturing devices, appliances, vehicles, robots, drones, etc.). IoT UEs may include machine type communications (MTC)/enhanced MTC (eMTC, also referred to as category (CAT)-M, Cat MI) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, in a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.), including base station 102 described above and further herein, may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as virtually distributing functionality for at least one unit, which can enable flexibility in network design. The various units of the disaggregated base station, or disaggregated RAN architecture, can be configured for wired or wireless communication with at least one other unit.

In an example, UE 104-a can synchronize timing with a satellite system 198, which may include a GNSS. UE 104-a, for example, can include a RSU, OBU, etc. In an example, UE 104-b may not be able to synchronize with the satellite system 198 (e.g., based on a region in which the UE 104-b is located), but the UE 104-b may be able to communicate with UE 104-a. As such, for example, communicating component 242 can transmit SLSS to UE 104-b. In this example, UB 104-b can receive the SLSS (e.g., via its own communicating component 242) and can synchronize timing based on the SLSS. As described above and further herein, communicating component 242 can transmit (or receive) SLSS over resources defined for SLSS without enabling SLSS configuration in the wireless communication system (e.g., in LTE V2X), which can prevent inconsistent logical slot index computation in the UEs that support SLSS and that do not support SLSS. In addition, in an example, communicating component 242 can transmit a SA to reserve resources for transmitting (or receiving) the SLSS to deter UEs that do not support SLSS from using the resources for data communications.

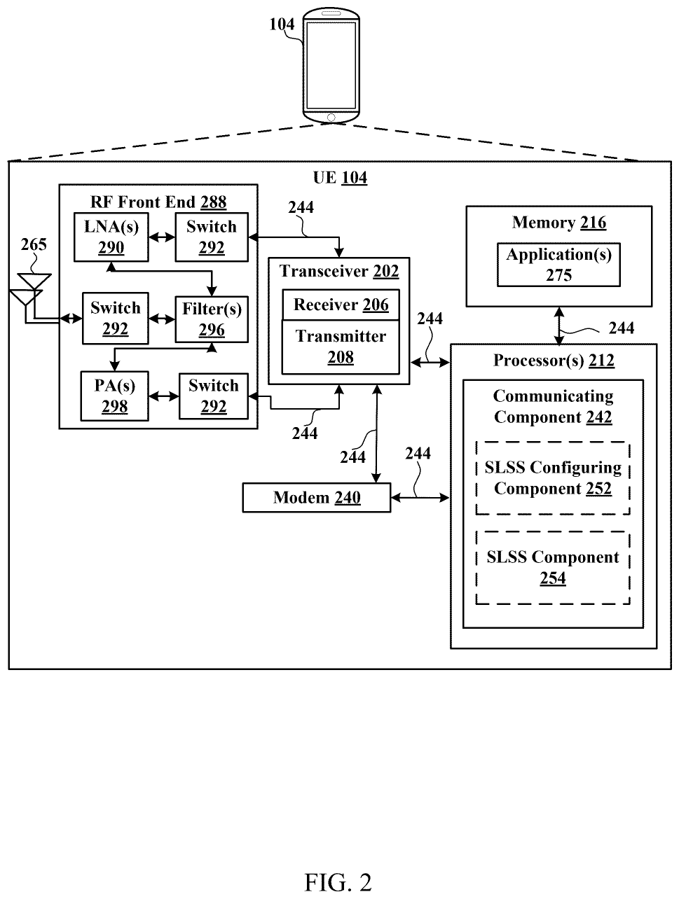

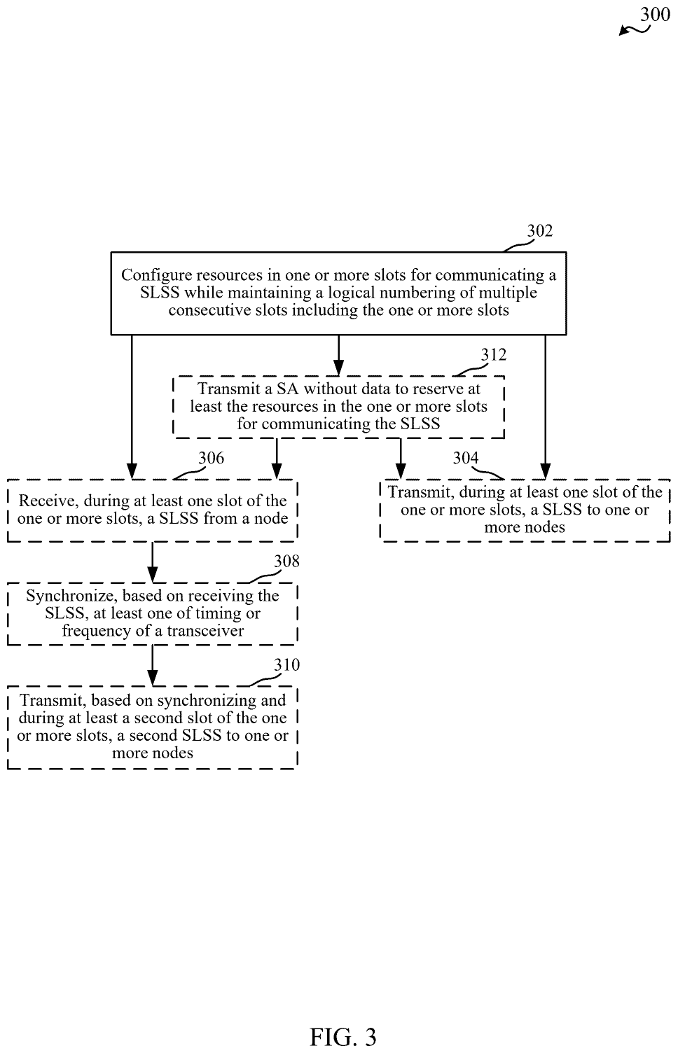

Turning now to FIGS. 2-5, aspects are depicted with reference to one or more components and one or more methods that may perform the actions or operations described herein, where aspects in dashed line may be optional. Although the operations described below in FIG. 3 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 2, one example of an implementation of UE 104 may include a variety of components, some of which have already been described above and are described further herein, including components such as one or more processors 212 and memory 216 and transceiver 202 in communication via one or more buses 244, which may operate in conjunction with modem 240 and/or communicating component 242 for communicating SLSSs, as described herein.

In an aspect, the one or more processors 212 can include a modem 240 and/or can be part of the modem 240 that uses one or more modem processors. Thus, the various functions related to communicating component 242 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with communicating component 242 may be performed by transceiver 202.

Also, memory 216 may be configured to store data used herein and/or local versions of applications 275 or communicating component 242 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining communicating component 242 and/or one or more of its subcomponents, and/or data associated therewith, when UE 104 is operating at least one processor 212 to execute communicating component 242 and/or one or more of its subcomponents.

Transceiver 202 may include at least one receiver 206 and at least one transmitter 208. Receiver 206 may include hardware and/or software executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102 or a SL transmitting UE. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware and/or software executable by a processor for transmitting data, the code comprising instructions and being stored in a memory (e.g., computer-readable medium). A suitable example of transmitter 208 may including, but is not limited to, an RF transmitter.

Moreover, in an aspect, UE 104 may include RF front end 288, which may operate in communication with one or more antennas 265 and transceiver 202 for receiving and transmitting radio transmissions, for example, receiving wireless communications transmitted by at least one base station 102 or a SL transmitting UE, transmitting wireless communications to at least one base station 102 or a SL receiving UE, etc. RF front end 288 may be connected to one or more antennas 265 and can include one or more low-noise amplifiers (LNAs) 290, one or more switches 292, one or more power amplifiers (PAS) 298, and one or more filters 296 for transmitting and receiving RF signals.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102, one or more other UEs in SL communications, etc. In an aspect, for example, modem 240 can configure transceiver 202 to operate at a specified frequency and power level based on the UE configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UB configuration information associated with UE 104 as provided by the network during cell selection and/or cell reselection.

In an aspect, communicating component 242 can optionally include a SLSS configuring component 252 for configuring resources for communicating a SLSS, and/or a SLSS component 254 for communicating (e.g., transmitting or receiving) a SLSS, as described herein.

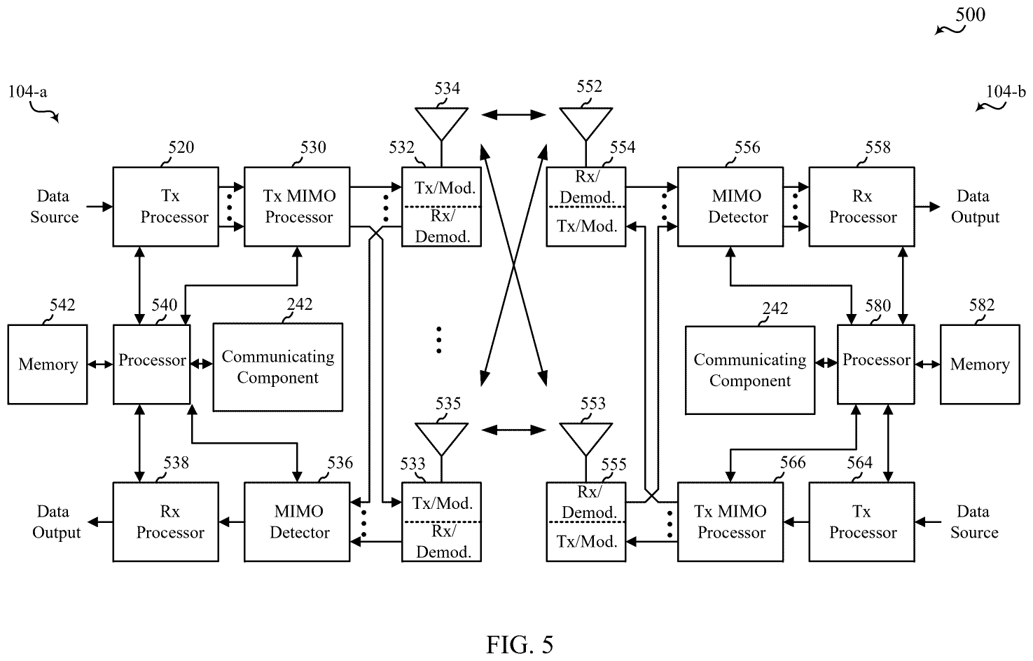

In an aspect, the processor(s) 212 may correspond to one or more of the processors described in connection with the UE in FIG. 5. Similarly, the memory 216 may correspond to the memory described in connection with the UE in FIG. 5.

FIG. 3 illustrates a flow chart of an example of a method 300 for communicating a SLSS. In an example, a UE (e.g., UE 104-a, UE 104-b), which can include a RSU, OBU, etc. in SL communications, can perform the functions described in method 300 using one or more of the components described in FIGS. 1 and 2.

In method 300, at Block 302, resources can be configured in one or more slots for communicating a SLSS while maintaining a logical numbering of multiple consecutive slots including the one or more slots. In an aspect, SLSS configuring component 252, e.g., in conjunction with processor(s) 212, memory 216, transceiver 202, communicating component 242, etc., can configure resources in one or more slots for communicating the SLSS while maintaining a logical numbering of multiple consecutive slots including the one or more slots. For example, SLSS configuring component 252 can configure the resources as one or multiple periodic resources, such as over slots occurring every N milliseconds, where N can be a positive integer.

In one example, SLSS configuring component 252 can configure two or three resources over a time period of a duration that is a multiple of 100 or 160 milliseconds. For example, SLSS configuring component 252 can configure 2 resources every N=160 ms (or a multiple of 160 ms). In an example, SLSS configuring component 252 can configure the resources as two resources at 0, 80 modulo 160. For example, SLSS configuring component 252 can configure the SLSS to be communicated (e.g., received or transmitted) in a slot corresponding to starting slot 0, and one or more other slots corresponding to 0 or 80 modulo 160.

In another example, SLSS configuring component 252 can configure 2 resources every N=100 ms (or a multiple of 100 ms). In an example, SLSS configuring component 252 can configure the resources as two resources at 0, 50 modulo 100. For example, SLSS configuring component 252 can configure the SLSS to be communicated (e.g., received or transmitted) in a slot corresponding to starting slot 0, and one or more other slots corresponding to 0 or 50 modulo 100.

In an example, SLSS configuring component 252 can select the slots for communicating SLSS according to parameters, such as the above parameters, which may be specified in the wireless communication technology (e.g., in the LTE V2X specification or standard), and communicating component 242 may accordingly not change the numbering of the slots, as SLSS resources can be fixed in the specification.

In method 300, optionally at Block 304, a SLSS can be transmitted to one or more nodes during at least one slot of the one or more slots. In an aspect, SLSS component 254, e.g., in conjunction with processor(s) 212, memory 216, transceiver 202. communicating component 242, etc., can transmit, during at least one slot of the one or more slots, the SLSS to one or more nodes. In one example, RSUs can transmit SLSSs in the configured slots, and OBUs may not transmit SLSSs in the configured slots. In this example, UE 104-a can include, or be included in, a RSU that transmits the SLSS to one or more nodes (e.g., one or more OBUs or RSUs) in the at least one slot.

In another example, OBUs can transmit SLSS in the configured slots (or at least a portion thereof). In one example, once an OBU is synchronized with a SLSS received from a RSU, the OBU may transmit SLSS as well in the configured slots (or at least a portion thereof). In this example, UE 104-a can include, or be included in, a OBU that synchronizes to a first SLSS and transmits a second SLSS in the at least one slot. In one example, the OBU can transmit SLSS at reduced intensity, which can include reduced power or a reduced periodicity of slots. For example, SLSS component 254 in a OBU may transmit SLSS in 0 modulo 160 slots, whereas RSU can transmit SLSS in 0 and 80 modulo 160 slots. In any case, for example, transmitting the SLSS may create more RSSI in the at least one resource, which can deter UEs (e.g., OBUs) that do not support SLSS from using the at least one resource for data communications. In another example, the UEs (e.g., OBUs) that do not support SLSS can perform an over-the-air software update to avoid transmitting on slots reserved for SLSS (e.g., as defined in the LTE V2X specification, as described above).

In method 300, optionally at Block 306, a SLSS can be received from a node during at least one slot of the one or more slots. In an aspect, SLSS component 254, e.g., in conjunction with processor(s) 212, memory 216, transceiver 202, communicating component 242, etc., can receive, during at least one slot of the one or more slots, the SLSS from the node. For example, the UE 104-a can be an OBU that receives the SLSS from a RSU or from another OBU in the at least one slot. In an example, as the SLSS is transmitted at a defined time or slot, the OBU receiving the SLSS can synchronize a time (or frequency) of its transceiver based on the SLSS.

In method 300, optionally at Block 308, at least one of timing or frequency of a transceiver can be synchronized based on receiving the SLSS. In an aspect, SLSS component 254, e.g., in conjunction with processor(s) 212, memory 216, transceiver 202, communicating component 242, etc., can synchronize, based on receiving the SLSS, at least one of timing or frequency of transceiver 202. For example, SLSS component 254 can synchronize the timing of the transceiver 202 to match the timing at which the SLSS is received or a time specified in the SLSS, etc.

In method 300, optionally at Block 310, a second SLSS can be transmitted to one or more nodes based on synchronizing and during at least a second slot of the one or more slots. In an aspect, SLSS component 254, e.g., in conjunction with processor(s) 212, memory 216, transceiver 202, communicating component 242, etc., can transmit, based on synchronizing (e.g., at Block 308) and during at least a second slot of the one or more slot (e.g., a next slot configured for SLSS communication), a second SLSS to one or more nodes (e.g., to one or more OBUs). The one or more nodes can similarly synchronize based on the SLSS and/or transmit additional SLSSs, in accordance with the previously described aspects.

In method 300, optionally at Block 312, a SA can be transmitted without data to reserve at least the resources in the one or more slots for communicating the SLSS. In an aspect, SLSS configuring component 252, e.g., in conjunction with processor(s) 212, memory 216, transceiver 202, communicating component 242, etc., can transmit the SA without data to reserve at least the resources in the one or more slots for communicating the SLSS. For example, SLSS configuring component 252 can transmit the SA in a sidelink channel that can be received by other UEs (e.g., OBUs), such as a PSCCH, PSSCH, etc. In this example, OBUs that do not support SLSS can receive the SA, and can avoid using the resources indicated in the SA for data communications. OBUs that support SLSS, RSUs, etc. can accordingly transmit SLSSs over the resources without interference and without interfering data communications of the OBUs that do not support SLSS. This can assist in freeing the resources for SLSS from OBUs that do not support SLSS when RSSI ranking alone may not be sufficient. In another aspect, SLSS configuring component 252 can transmit a SA without data in the first 2 RBs of the slots to reserve SLSS slots, and the devices that do not support SLSS may refrain from using these slots for data communications based on the SA, as described.

In an example, SLSS periodicity can be set to 100 or 200 millisecond to support this functionality, as P_rsvp in the SA may be limited to 20, 50, 100, 200, 300 . . . , 1000. SA content from different UEs can be identical so it can be single frequency network (SFN) combined at a receiver (e.g., at a OBU that does not support SLSS). As such, for example, the periodicity of the resources for communicating SLSS may be based on the periodicity of the SA. In one example, not all UEs need to send this SA, and sending the SA can be based on a periodicity, a timer (e.g., expiration of a timer maintained by the SLSS configuring component 252), a probability, etc. Accordingly, for example, SLSS configuring component 252 can transmit the SA based on the periodicity, timer, probability, etc., the existence of, or parameters for, which may be indicated in the LTE V2X specification, configured by a RSU or other device in SL communication to the OBU, etc. In addition, for example, a UE transmitting SLSS may not transmit this SA at the same time, and as such, in one example, OBUs can send this SA instead of, or more frequently than, RSUs. In one example, when SA is sent periodically, SLSS configuring component 252 of an OBU can monitor which 100 ms or 50 ms period that lacks SA coverage and elect itself to transmit SA in such period.

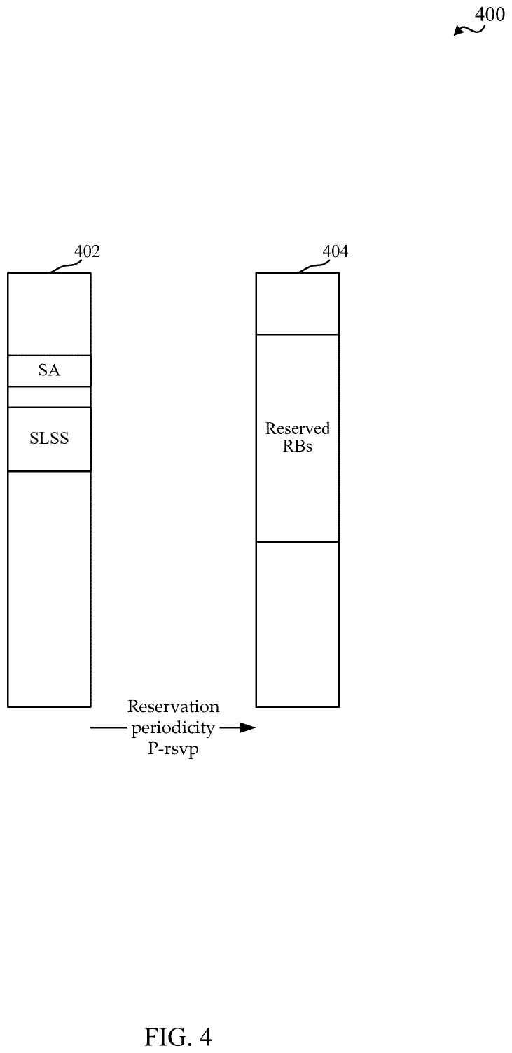

FIG. 4 illustrates an example of a resource allocation 400 for SA and SLSS transmission and reserving RBs. For example, a SLSS configuring component 252 of a OBU can transmit a SA in slot 402, which can reserve the slot 402 or a subsequent slot 404 for SLSS communication, by indicating one or more parameters, such as a P_rsvp indicating the periodicity of the reserved resources. An OBU receiving the SA that does not support SLSS can avoid data transmission in the slot 402 and/or slot 404 based on the SA indicating the reserved slots or corresponding reserved resources (RBs) in the slots 402 and/or 404 (and/or subsequent slots based on the periodicity). In addition, for example, SLSS component 254 of a RSU (and/or a different OBU) can transmit the SLSS in slot 402 and/or another SLSS in the reserved RBs in slot 404. In yet another example, SLSS component 254 of the OBU that transmitted the SA in slot 402 may transmit a SLSS in the reserved RBs of slot 404. Moreover, in various examples, one or more OBUs (or RSUs) that support SLSS communications can receive the SLSS transmitted in slot 402, and can synchronize timing based on the received SLSS, as described.

In one specific example, N=100 ms, and 2 resources can be specified within each N for SLSS communication, such as at 0, 50 modulo 100. SLSS configuring component 252 of a OBU can transmit a common SA to reserve 20 resource blocks (RBs) (e.g., 2 subchannels), starting from RB 40. SLSS signal, which can be transmitted by a different OBU or RSU, can start from RB 47 and end at RB 52. Thus, for example, the SA can reserve, in the one or more slots, a larger set of resources that includes the resources configured for communicating SLSS. In one example, P_rsvp can be either 50 or 100. Where P_rsvp=50, there can be a single reserve chain for reserving resources in slots having logical slot indices 0, 50, 100, 150, etc. (which may each be 50 ms apart). In another example, where P_rsvp=100, the can be 2 reserve chains; one for reserving resources in slots having logical slot indices 0, 100, 200, etc. (which may each be 100 ms apart); and one for reserving resources in slots having logical slot indices 50, 150, 250, etc. For example, RSUs may not transmit SA reserving SLSS subchannels. In one example, SLSS component 254 of an OBU can transmit SA reserving SLSS subchannels with a periodicity of 1000 ms. In this example, at a given time, roughly ten percent of OBUs can transmit SA reserving SLSS subchannels. For example, SLSS configuring component 252 of a given OBU can monitor and detect that there are SA from other OBUs at slots having logical slot indices 0, 50, 100, 150, etc., but not in slot 750. In this example, SLSS configuring component 252 can transmit SA reserving SLSS at slots having logical slot indices 750, 1750, 2750, etc. (which may be 1000 ms apart), based on this detection and the 1000 ms periodicity, which may be indicated in LTE V2X specification or otherwise configured to the OBU.

FIG. 5 is a block diagram of a MIMO communication system 500 including UEs 104-a, 104-b. The MIMO communication system 500 may illustrate aspects of the wireless communication access network 100 described with reference to FIG. 1. The UE 104-a may be an example of aspects of the UE 104 described with reference to FIGS. 1 and 3. The UE 104-a may be equipped with antennas 534 and 535, and the UE 104-b may be equipped with antennas 552 and 553. In the MIMO communication system 500, the UEs 104-a, 104-b may be able to send data over multiple communication links at the same time. Each communication link may be called a “layer” and the “rank” of the communication link may indicate the number of layers used for communication. For example, in a 2×2 MIMO communication system where UE 104-a transmits two “layers,” the rank of the communication link between the UE 104-a and the UE 104-b is two.

At the UE 104-a, a transmit (Tx) processor 520 may receive data from a data source. The transmit processor 520 may process the data. The transmit processor 520 may also generate control symbols or reference symbols. A transmit MIMO processor 530 may perform spatial processing (e.g., precoding) on data symbols, control symbols, or reference symbols, if applicable, and may provide output symbol streams to the transmit modulator/demodulators 532 and 533. Each modulator/demodulator 532 through 533 may process a respective output symbol stream (e.g., for OFDM, etc.) to obtain an output sample stream. Each modulator/demodulator 532 through 533 may further process (e.g., convert to analog, amplify, filter, and upconvert) the output sample stream to obtain a DL signal. In one example, DL signals from modulator/demodulators 532 and 533 may be transmitted via the antennas 534 and 535, respectively.

The UE 104-b may be an example of aspects of the UEs 104 described with reference to FIGS. 1 and 3. At the UE 104-b, the UE antennas 552 and 553 may receive the signals from the UE 104-a (e.g., over a sidelink) and may provide the received signals to the modulator/demodulators 554 and 555, respectively. Each modulator/demodulator 554 through 555 may condition (e.g., filter, amplify, downconvert, and digitize) a respective received signal to obtain input samples. Each modulator/demodulator 554 through 555 may further process the input samples (e.g., for OFDM, etc.) to obtain received symbols. A MIMO detector 556 may obtain received symbols from the modulator/demodulators 554 and 555, perform MIMO detection on the received symbols, if applicable, and provide detected symbols. A receive (Rx) processor 558 may process (e.g., demodulate, deinterleave, and decode) the detected symbols, providing decoded data for the UE 104-b to a data output, and provide decoded control information to a processor 580, or memory 582.

At the UE 104-b, a transmit processor 564 may receive and process data from a data source. The transmit processor 564 may also generate reference symbols for a reference signal. The symbols from the transmit processor 564 may be precoded by a transmit MIMO processor 566 if applicable, further processed by the modulator/demodulators 554 and 555 (e.g., for SC-FDMA, etc.), and be transmitted to the UE 104-a in accordance with the communication parameters received from the UE 104-a. At the UE 104-a, the signals from the UE 104-b may be received by the antennas 534 and 535, processed by the modulator/demodulators 532 and 533, detected by a MIMO detector 536 if applicable, and further processed by a receive processor 538. The receive processor 538 may provide decoded data to a data output and to the processor 540 or memory 542.

The processor 540 and/or 580 may in some cases execute stored instructions to instantiate a communicating component 242 (see e.g., FIGS. 1 and 3).

The components of the UEs 104-a, 104-b may, individually or collectively, be implemented with one or more ASICs adapted to perform some or all of the applicable functions in hardware. Each of the noted modules may be a means for performing one or more functions related to operation of the MIMO communication system 500. Similarly, the components of the UE 104-a may, individually or collectively, be implemented with one or more ASICs adapted to perform some or all of the applicable functions in hardware. Each of the noted components may be a means for performing one or more functions related to operation of the MIMO communication system 500.

The following aspects are illustrative only and aspects thereof may be combined with aspects of other embodiments or teaching described herein, without limitation.

Aspect 1 is a method for wireless communication including configuring resources in one or more slots for communicating a SLSS while maintaining a logical numbering of multiple consecutive slots including the one or more slots and at least one of: receiving, during at least one slot of the one or more slots, a SLSS from a node; or transmitting, during at least one slot of the one or more slots, a SLSS to one or more nodes.

In Aspect 2, the Aspect of claim 1 includes, based on receiving the SLSS from the node, synchronizing at least one of timing or frequency of a transceiver based on the SLSS.

In Aspect 3, the method of Aspect 2 includes, based on synchronizing at least one of the timing or frequency of the transceiver based on the SLSS, transmitting, during at least a second slot of the one or more slots, a second SLSS to one or more nodes.

In Aspect 4, the method of any of Aspects 1 to 3 includes where the resources include two or three resources over a time period of a duration that is a multiple of 100 or 160 milliseconds.

In Aspect 5, the method of any of Aspects 1 to 4 includes transmitting a SA without data to reserve at least the resources in the one or more slots for communicating the SLSS.

In Aspect 6, the method of Aspect 5 includes transmitting the SA is based on at least one of a periodicity or expiration of a timer or a probability.

In Aspect 7, the method of any of Aspects 5 or 6 includes where a periodicity of the resources is based on a periodicity of the SA.

In Aspect 8, the method of any of Aspects 5 to 7 includes where transmitting the SA is based at least in part on determining that another SA is not transmitted by another UE for the one or more slots.

In Aspect 9, the method of any of Aspects 5 to 8 includes where the SA reserves, in the one or more slots, a larger set of resources including the resources configured for communicating SLSS.

Aspect 10 is an apparatus for wireless communication including a transceiver, a memory configured to store instructions, and one or more processors communicatively coupled with the memory and the transceiver, where the one or more processors are configured to execute the instructions to cause the apparatus to perform one or more of the methods of any of Aspects 1 to 9.

Aspect 11 is an apparatus for wireless communication including means for performing one or more of the methods of any of Aspects 1 to 9.

Aspect 12 is a computer-readable medium including code executable by one or more processors for wireless communications, the code including code for performing one or more of the methods of any of Aspects 1 to 9.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, hardwiring, or combinations of any of these. Features implementing functions may also be physically located at various positions, including being distributed such that portions of functions are implemented at different physical locations. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. Also, as used herein, including in the claims, “or” as used in a list of items prefaced by “at least one of” indicates a disjunctive list such that, for example, a list of “at least one of A, B, or C” means A or B or C or AB or AC or BC or ABC (A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
a memory configured to store instructions; and
one or more processors communicatively coupled with the transceiver and the memory, wherein the one or more processors are configured to:
configure resources in one or more slots for communicating a sidelink synchronization signal (SLSS) while maintaining a logical numbering of multiple consecutive slots including the one or more slots; and
at least one of:
receive, during at least one slot of the one or more slots, a SLSS from a node; or
transmit, during at least one slot of the one or more slots, a SLSS to one or more nodes.

2. The apparatus of claim 1, wherein the one or more processors are further configured to, based on receiving the SLSS from the node, synchronize at least one of timing or frequency of a transceiver based on the SLSS.

3. The apparatus of claim 2, wherein the one or more processors are further configured to, based on synchronizing at least one of the timing or frequency of the transceiver based on the SLSS, transmit, during at least a second slot of the one or more slots, a second SLSS to one or more nodes.

4. The apparatus of claim 1, wherein the resources include two or three resources over a time period of a duration that is a multiple of 100 or 160 milliseconds.

5. The apparatus of claim 1, wherein the one or more processors are further configured to transmit a scheduling assignment (SA) without data to reserve at least the resources in the one or more slots for communicating the SLSS.

6. The apparatus of claim 5, wherein the one or more processors are configured to transmit the SA based on at least one of a periodicity or expiration of a timer or a probability.

7. The apparatus of claim 5, wherein a periodicity of the resources is based on a periodicity of the SA.

8. The apparatus of claim 5, wherein the one or more processors are configured to transmit the SA based at least in part on determining that another SA is not transmitted by another UE for the one or more slots.

9. The apparatus of claim 5, wherein the SA reserves, in the one or more slots, a larger set of resources including the resources configured for communicating SLSS.

10. A method for wireless communication, comprising:
configuring resources in one or more slots for communicating a sidelink synchronization signal (SLSS) while maintaining a logical numbering of multiple consecutive slots including the one or more slots; and
at least one of:
receiving, during at least one slot of the one or more slots, a SLSS from a node; or
transmitting, during at least one slot of the one or more slots, a SLSS to one or more nodes.

11. The method of claim 10, further comprising, based on receiving the SLSS from the node, synchronizing at least one of timing or frequency of a transceiver based on the SLSS.

12. The method of claim 11, further comprising, based on synchronizing at least one of the timing or frequency of the transceiver based on the SLSS, transmitting, during at least a second slot of the one or more slots, a second SLSS to one or more nodes.

13. The method of claim 10, wherein the resources include two or three resources over a time period of a duration that is a multiple of 100 or 160 milliseconds.

14. The method of claim 10, further comprising transmitting a scheduling assignment (SA) without data to reserve at least the resources in the one or more slots for communicating the SLSS.

15. The method of claim 14, wherein transmitting the SA is based on at least one of a periodicity or expiration of a timer or a probability.

16. The method of claim 14, wherein a periodicity of the resources is based on a periodicity of the SA.

17. The method of claim 14, wherein transmitting the SA is based at least in part on determining that another SA is not transmitted by another UE for the one or more slots.

18. The method of claim 14, wherein the SA reserves, in the one or more slots, a larger set of resources including the resources configured for communicating SLSS.

19. An apparatus for wireless communication, comprising:
means for configuring resources in one or more slots for communicating a sidelink synchronization signal (SLSS) while maintaining a logical numbering of multiple consecutive slots including the one or more slots; and
at least one of:
means for receiving, during at least one slot of the one or more slots, a SLSS from a node; or
means for transmitting, during at least one slot of the one or more slots, a SLSS to one or more nodes.

20. The apparatus of claim 19, further comprising means for, based on receiving the SLSS from the node, synchronizing at least one of timing or frequency of a transceiver based on the SLSS.

21. The apparatus of claim 20, further comprising means for, based on synchronizing at least one of the timing or frequency of the transceiver based on the SLSS, transmitting, during at least a second slot of the one or more slots, a second SLSS to one or more nodes.

22. The apparatus of claim 19, wherein the resources include two or three resources over a time period of a duration that is a multiple of 100 or 160 milliseconds.

23. The apparatus of claim 19, further comprising means for transmitting a scheduling assignment (SA) without data to reserve at least the resources in the one or more slots for communicating the SLSS.

24. The apparatus of claim 23, wherein the means for transmitting the SA transmits the SA based on at least one of a periodicity or expiration of a timer or a probability.

25. A computer-readable medium, comprising code executable by one or more processors for wireless communications, the code comprising:
code for configuring resources in one or more slots for communicating a sidelink synchronization signal (SLSS) while maintaining a logical numbering of multiple consecutive slots including the one or more slots; and
at least one of:
code for receiving, during at least one slot of the one or more slots, a SLSS from a node; or
code for transmitting, during at least one slot of the one or more slots, a SLSS to one or more nodes.

26. The computer-readable medium of claim 25, further comprising code for, based on receiving the SLSS from the node, synchronizing at least one of timing or frequency of a transceiver based on the SLSS.

27. The computer-readable medium of claim 26, further comprising code for, based on synchronizing at least one of the timing or frequency of the transceiver based on the SLSS, transmitting, during at least a second slot of the one or more slots, a second SLSS to one or more nodes.

28. The computer-readable medium of claim 25, wherein the resources include two or three resources over a time period of a duration that is a multiple of 100 or 160 milliseconds.

29. The computer-readable medium of claim 25, further comprising code for transmitting a scheduling assignment (SA) without data to reserve at least the resources in the one or more slots for communicating the SLSS.

30. The computer-readable medium of claim 29, wherein the code for transmitting the SA transmits the SA based on at least one of a periodicity or expiration of a timer or a probability.
